(19) United States
(12) Patent Application Publication
(10) Pub. No.: US 2026/0080188 A1
(43) Pub. Date: Mar. 19, 2026

(54) PROMPT GENERATING DEVICE AND METHOD

(71) Applicants: HON HAI PRECISION INDUSTRY CO., LTD., New Taipei City (TW); Foxconn Technology Group Co., Ltd., Guangdong Province (CN)

(72) Inventors: Yung-Hui LI, New Taipei City (TW); I-Bin LIAO, New Taipei City (TW)

(21) Appl. No.: 19/326,690

(22) Filed: Sep. 11, 2025

Related U.S. Application Data
(60) Provisional application No. 63/694,208, filed on Sep. 13, 2024.

(51) Int. Cl. G06F 40/40

(52) U.S. Cl. CPC G06F 40/40

(57) ABSTRACT

A prompt generating device and method are provided. The prompt generating device receives a situational question. The prompt generating device transmits a target personality category among personality categories and the situational question to a prompt generator to generate candidate prompts corresponding to the target personality category and reward signals corresponding to the candidate prompts, and the prompt generator is trained based on a large language model and a reward model corresponding to the personality categories. The prompt generating device determines a best prompt from the candidate prompts based on the reward signals corresponding to the candidate prompts.

This application claims priority to US Provisional Application Serial Number 63/694,208, filed September 13, 2024, which is herein incorporated by reference in its entirety.

### BACKGROUND

### TECHNICAL FIELD

The present disclosure relates to a prompt generating device and method. Specifically, the present disclosure relates to a prompt generating device and method capable of automatically generating a best prompt to guide a large language model to generate a personalized reply.

### DESCRIPTION OF RELATED ART

In recent years, in various industrial fields (e.g., autonomous driving), the demand for conducting dialogues with users based on large language models has been continuously increasing, where technologies for designing prompts to elicit large language models to generate personalized replies have been successively proposed.

In the prior art, prompts input into large language models are generated through manual design, and the personalized replies generated by the large language models elicited by the prompts are also manually evaluated. However, under such circumstances, the processes of manually designing prompts and manually evaluating replies are quite time-consuming and costly, and cannot effectively elicit the large language models to generate personalized replies.

In view of this, how to provide a prompt generating technology that is capable of automatically designing prompts to reduce the time cost of designing prompts and that can guide the large language model to effectively generate personalized replies is an urgent goal that the industry needs to strive for.

### SUMMARY

One object of the present disclosure is to provide a prompt generating device. The prompt generating device comprises a transceiver interface and a processor. The transceiver interface is configured to receive a situational question. The processor is electrically connected to the transceiver interface. The processor transmits a target personality category among a plurality of personality categories and the situational question to a prompt generator to generate a plurality of candidate prompts corresponding to the target personality category, wherein the prompt generator is trained based on a large language model and a reward model corresponding to the personality categories. The processor determines a best prompt from the candidate prompts based on a plurality of reward signals corresponding to the candidate prompts.

A further object of the present disclosure is to provide a prompt generating method. The prompt generating method is for use in an electronic device. The prompt generating method comprises the following steps: transmitting a target personality category among a plurality of personality categories and a situational question to a prompt generator to generate a plurality of candidate prompts corresponding to the target personality category, wherein the prompt generator is trained based on a large language model and a reward model corresponding to the personality categories; and determining a best prompt from the candidate prompts based on a plurality of reward signals corresponding to the candidate prompts.

According to the prompt generating technology (including at least the device and the method) provided in the present disclosure, a situational question is converted into a plurality of candidate prompts through a prompt generator, and a best prompt is determined from the candidate prompts. Subsequently, according to the present disclosure, a prompt generator is trained through reinforcement learning based on a large language model and a reward model. Furthermore, according to the present disclosure, the best prompt is transmitted to a large language model to generate one response message corresponding to the target personality category. Since according to the present disclosure, prompts can be automatically generated through the prompt generator trained based on reinforcement learning, the prompt generating technology provided in the present disclosure reduces the time cost of designing prompts and guides the large language model to effectively generate personalized replies.

The detailed technology and embodiments of the present disclosure are described below with reference to the drawings, so that persons having ordinary knowledge in the technical field to which the present disclosure pertains can understand the technical features of the claimed invention.

### BRIEF DESCRIPTION OF THE DRAWINGS

FIG. 1 illustrates a schematic structural diagram of a prompt generating device according to a first embodiment;

FIG. 2 illustrates a schematic diagram of a storage according to the first embodiment;

FIG. 3 illustrates a schematic diagram of a prompt generating process according to the first embodiment;

FIG. 4 illustrates a schematic diagram of a prompt generator training process according to some embodiments;

FIG. 5 illustrates a schematic diagram of a reward model training process according to some embodiments;

FIG. 6 illustrates a schematic diagram of a generation process of enhanced training instructions, enhanced training responses, and an evolutionary enhancement method according to some embodiments;

FIG. 7 illustrates a schematic diagram of an enhanced instruction generation process according to some embodiments; and

FIG. 8 illustrates a flowchart of a prompt generating method according to a second embodiment.

### DETAILED DESCRIPTION

The prompt generating device provided in the present disclosure will be explained below by way of embodiments. However, these embodiments are not intended to limit the present disclosure to being implemented only in any environment, application, or manner as described in these embodiments. Therefore, the description of the embodiments is only for the purpose of illustrating the present disclosure, not for limiting the scope of the present disclosure. It should be understood that in the following embodiments and drawings, elements not directly related to the present disclosure are omitted and not shown, and the sizes of the elements and the size ratios between elements are merely exemplary and not intended to limit the scope of the present disclosure.

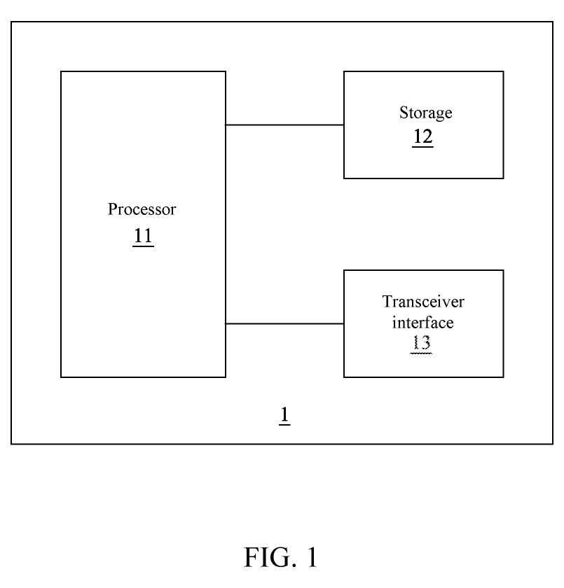

For a prompt generating device according to a first embodiment of the present disclosure, its schematic diagram is illustrated in FIG. 1. As shown in FIG. 1, the prompt generating device 1 includes a processor 11, a storage 12, and a transceiver interface 13, and the processor 11 is electrically connected to the storage 12 and the transceiver interface 13.

The prompt generating device 1 of the present disclosure can be used in any environment where a user can interact with a large language model. For example, the prompt generating device 1 may be disposed inside a vehicle, allowing interaction between a user (e.g., a driver or passenger) and the prompt generating device 1.

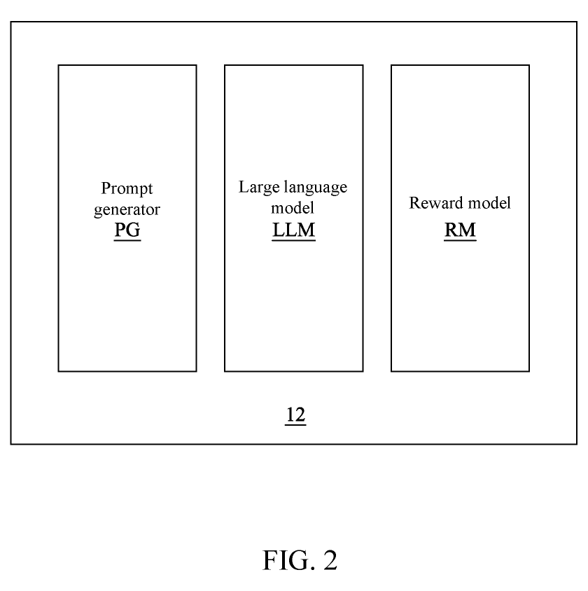

In the present embodiment, as shown in FIG. 2, the storage 12 is configured to store a prompt generator PG, a large language model LLM and a reward model RM. The prompt generator PG is a language model capable of converting an input prompt into an advanced prompt (e.g., converting an input prompt into a prompt with a different tone or more complex grammar). The large language model LLM is a large language model capable of understanding an input prompt and generating a reply corresponding to the input prompt. The reward model RM is a regression model capable of generating a reward (e.g., a score indicating the degree of conformity of an input text to a specific personality) for input information.

In the present embodiment, the transceiver interface 13 is configured to receive a situational question. For example, the prompt generating device 1 further includes a sensor (e.g., a microphone). The situational question received by the transceiver interface 13 is generated when the processor 11 transcribes a voice signal sensed by the sensor into a textual form of the situational question when a user speaks.

In certain embodiments, the prompt generating device 1 further includes a human-machine interface. The situational question received by the transceiver interface 13 is a situational question input by a user operating the human-machine interface. For example, a user may operate a touch screen interface to input the situational question in a textual form. It should be noted that the human-machine interface is an interface that can be controlled by a user to generate input signals and reports system status back to the user.

It should be noted that the processor 11 may be various processing units, a Central Processing Unit (CPU), a microprocessor, or other computing devices known to persons having ordinary knowledge in the technical field to which the present case pertains. The storage 12 may be a memory, a Universal Serial Bus (USB) disk, a hard disk, an optical disk, a flash drive, or any other storage medium or circuit with the same function known to persons having ordinary knowledge in the technical field to which the present case pertains. The transceiver interface 13 is an interface capable of receiving and transmitting data, or other interfaces capable of receiving and transmitting data known to persons having ordinary knowledge in the technical field to which the present case pertains. The transceiver interface 13 may receive data from sources such as external devices, external web pages, external applications, etc.

In the present disclosure, the main principle involves transmitting a target personality category and a situational question to the prompt generator PG to generate a best prompt, and guiding the large language model LLM to generate a response message corresponding to the target personality category based on the best prompt. The implementation details related to the present disclosure will be described in detail in the following paragraphs.

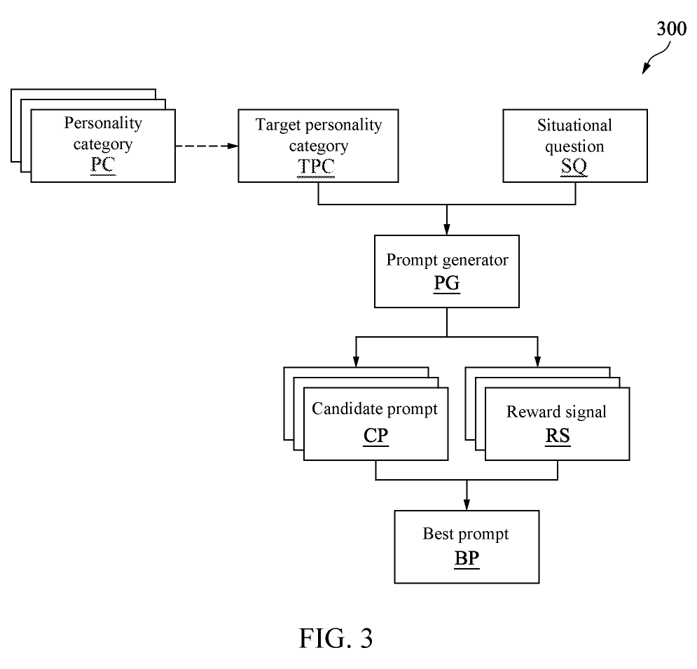

In the first embodiment, for ease of explanation, please refer to a schematic diagram 300 of a prompt generating process in FIG. 3. Specifically, the processor 11 transmits a target personality category TPC among a plurality of personality categories PC and the situational question SQ to the prompt generator PG to generate a plurality of candidate prompts CP corresponding to the target personality category TPC and a plurality of reward signals RS corresponding to the candidate prompts CP.

First, the storage 12 stores a plurality of personality categories PC. The personality categories PC may be determined based on a personalized textual dataset used in the present disclosure. For example, the personalized textual dataset may be a Big Five Personality Dataset, and the personality categories PC are five personality traits described in the Big Five Personality Dataset: Openness, Conscientiousness, Extraversion, Agreeableness, and Neuroticism.

It should be noted that the personalized textual dataset used in the present disclosure is not limited to the Big Five Personality Dataset mentioned above, it can also be any dataset containing texts corresponding to different personality traits.

Next, the target personality category TPC is one of the personality categories PC, and the target personality category TPC can be determined by the user. For example, the processor 11 controls the human-machine interface to display a plurality of option buttons corresponding to the personality categories PC, and the user operates the human-machine interface to select one of the option buttons to determine the target personality category TPC.

In the present embodiment, the prompt generator PG is a language model capable of converting an input prompt into a more advanced prompt. The processor 11 transmits the target personality category TPC and the situational question SQ to the prompt generator PG to generate a plurality of candidate prompts CP corresponding to the target personality category TPC. In certain embodiments, the target personality category TPC and the situational question SQ can be input to the prompt generator PG in a textual form.

It should be noted that since the candidate prompts CP are generated by the prompt generator PG based on the target personality category TPC and the situational question SQ, the contents described by the candidate prompts CP and the situational question SQ are similar, but the narrative styles are different.

For example, the target personality category TPC is "Openness", the situational question SQ is "Hello, what's the weather like today?", and the candidate prompts CP generated by the prompt generator PG include a first candidate prompt and a second candidate prompt. The first candidate prompt is "Hi! What do you think the weather is like today?", and the second candidate prompt is "Hello, I really want to know about today's weather condition!". From the situational question SQ and the candidate prompts CP, it can be seen that the contents of both the situational question SQ and the candidate prompts CP are "inquiring about today's weather", but the narrative styles of the candidate prompts CP (e.g., tone, interjections, punctuation, etc.) are different.

Furthermore, the prompt generator PG can also generate a plurality of reward signals RS corresponding to the candidate prompts CP, where each of the reward signals RS is presented as a numerical value, and the reward signals RS are configured to indicate the degree of conformity of individual candidate prompts CP to the target personality category TPC. In certain embodiments, the reward signals RS are configured to indicate the degree of conformity of individual candidate prompts CP to individual personality categories PC.

It should be noted that an initial model of the prompt generator PG is a pre-trained language model. The prompt generator PG needs to undergo fine-tuning training to improve the capability of the prompt generator PG to generate prompts. Specifically, the prompt generator PG is trained based on the large language model LLM and a reward model RM corresponding to the personality categories PC.

In the first embodiment, specifically, the processor 11 determines a best prompt BP from the candidate prompts CP based on the reward signals RS corresponding to the candidate prompts CP.

It should be noted that the candidate prompts CP are a plurality of different discrete prompts explored by the prompt generator PG in a multi-dimensional vocabulary space, and the prompt generator PG tests the candidate prompts CP to select the one with the best performance as the best prompt BP. For example, the processor 11 selects the candidate prompt CP corresponding to the highest reward signal RS from the candidate prompts CP as the best prompt BP.

It should be noted that the best prompt BP is configured to instruct the large language model LLM to generate one response message corresponding to the target personality category TPC. In other words, the best prompt BP will be used to amplify the personality characteristic manifestations of the large language model LLM in generating the response message, allowing the content of the response message to be more consistent with the target personality category TPC.

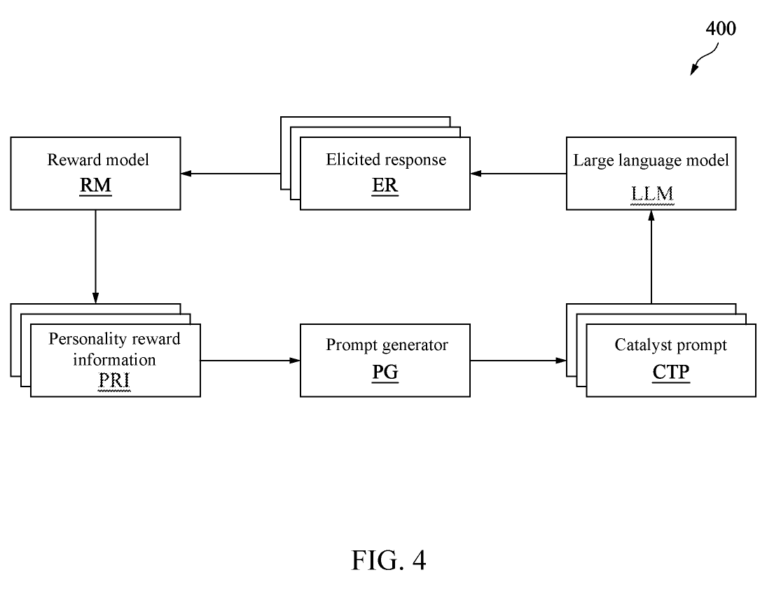

In certain embodiments, the prompt generator PG is trained through reinforcement learning. For ease of explanation, please refer to a schematic diagram 400 of a prompt generator training process in FIG. 4. First, the processor 11 transmits a plurality of catalyst prompts CTP to the large language model LLM to generate a plurality of elicited responses ER corresponding to the catalyst prompts CTP. In other words, the elicited responses ER are personalized responses generated by the large language model LLM upon receiving the catalyst prompts CTP and being elicited.

It should be noted that the catalyst prompts CTP are generated based on the prompt generator PG. The prompt generator PG is a language model, so according to the present disclosure, the prompt generator PG can generate the catalyst prompts CTP by giving the prompt generator PG simple instructions. For example, when the prompt generator PG is given an instruction "Please generate a plurality of prompts about weather conditions", the prompt generator PG can generate a plurality of catalyst prompts CTP corresponding to the instruction in a textual form.

Next, the processor 11 transmits the elicited responses ER to the reward model RM to generate a plurality of personality reward information PRI corresponding to the elicited responses ER, where each of the personality reward information PRI includes a plurality of personality reward scores corresponding to the personality categories PC.

For example, with the five personality traits in the Big Five Personality Dataset as an example of the personality categories PC, each of the personality reward information PRI includes reward scores corresponding to the five personality categories: Openness, Conscientiousness, Extraversion, Agreeableness, and Neuroticism.

It should be noted that each of the reward scores may be a numerical value within a range (for example: a maximum value of 1, a minimum value of 0), where the numerical value is used to indicate the degree of conformity to the personality category PC. For example, among the plurality of personality reward information PRI of one elicited response ER, the personality reward score corresponding to Openness is 0.9, to indicate a higher degree of conformity of the elicited response ER to Openness; while the personality reward score corresponding to Agreeableness is 0.1, to indicate a lower degree of conformity of the elicited response ER to Agreeableness.

Finally, the processor 11 trains the prompt generator PG through reinforcement learning based on the catalyst prompts CTP and the personality reward information PRI. In other words, the reward model RM is configured to evaluate each of the elicited responses ER generated by the large language model LLM against different personality categories PC, thereby training the prompt generator PG to enhance the prompt generator PG's comprehension capability of "which personality category PC the elicited response ER elicited by the catalyst prompts CTP generated by the prompt generator PG itself corresponds to". Furthermore, the training process of the prompt generator PG can be repeated to further enhance the capability of the prompt generator PG.

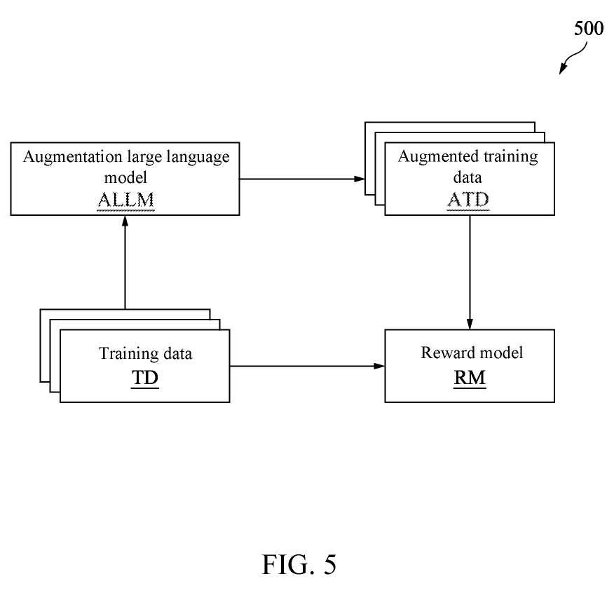

In certain embodiments, for ease of explanation, please refer to a schematic diagram 500 of a reward model training process in FIG. 5. Specifically, the processor 11 trains the reward model RM based on a plurality of training data TD corresponding to the personality categories PC. It should be noted that the training data TD includes a plurality of training texts, and each training text corresponds to one of the plurality of personality categories PC. The training data TD can be generated based on various methods; for example, the training data TD can be provided by open-source personalized text datasets (e.g., Big Five Personality Dataset, PANDORA). For another example, the training data TD can also be generated by manually inputting texts and manually annotating the corresponding personality categories PC.

In certain embodiments, according to the present disclosure, data augmentation is further performed on the training data TD to increase the data volume and diversity of the training data TD. Specifically, the processor 11 transmits the training data TD corresponding to the personality categories PC to an augmentation large language model ALLM to generate a plurality of augmented training data ATD corresponding to the personality categories PC. Then, the processor 11 trains the reward model RM based on the augmented training data ATD corresponding to the personality categories PC.

It should be noted that the augmentation large language model ALLM can be any large language model capable of converting an input text into an advanced text (e.g., converting the input text into a text with more complex grammar).

In certain embodiments, an augmentation instruction can be manually input to the augmentation large language model ALLM, where the augmentation instruction is configured to indicate an augmentation form of the augmented training data ATD generated by the augmentation large language model ALLM. For example, the augmentation instruction may be "Use more complex grammar to augment the input text" or "Use a different narrative sequence to augment the input text", where "more complex grammar" and "different narrative sequence" are augmentation forms indicated by the augmentation instruction.

In certain embodiments, specifically, the processor 11 transmits the best prompt BP to the large language model LLM to generate the response message corresponding to the target personality category TPC.

It should be noted that if the processor 11 transmits the situational question SQ to the large language model LLM, the large language model LLM will generate one basic response message. Since the basic response message is elicited based on the situational question SQ, the response message is elicited based on the best prompt BP, and the best prompt BP is generated by the prompt generator PG based on the situational question SQ, the contents described by the basic response message and the response message have a certain degree of similarity.

Subsequently, since the best prompt BP is used to amplify the personality characteristic manifestations of the large language model LLM in generating the response message, the response message conforms more to the target personality category TPC compared to the basic response message.

For example, the target personality category TPC is "Openness", and the situational question SQ is "You are attending a concert or live performance. How much do you enjoy the atmosphere of the crowd and the energy of the event?". The basic response message elicited based on the situational question SQ is "I enjoy the atmosphere of the event, but I do not enjoy the crowd". The prompt generating device 1 generates the best prompt BP based on the situational question SQ, and the response message generated based on the best prompt BP is "I enjoy the atmosphere of the crowd and the energy of the event". Evidently, the response message elicited by the best prompt BP conforms more to the target personality category TPC of "Openness" compared to the basic response message elicited based on the situational question SQ.

In certain embodiments, the prompt generating device 1 can display the response message through the human-machine interface during interaction with the user, and inquire with the user through the human-machine interface. The user can operate the human-machine interface to generate a confirmation signal, and further train and update the prompt generator PG based on this reward.

For example, the processor 11 controls a touch screen interface to display the response message and controls the touch screen interface to display a question message (e.g., "Which personality category do you think this reply conforms to?"). Then, the processor 11 controls the touch screen interface to display a plurality of reward buttons corresponding to the personality categories PC (e.g., a button corresponding to "Openness", a button corresponding to "Conscientiousness", etc.). If it is assumed that the user believes that the response message conforms to "Openness", then the user may operate the touch screen interface to select the "Openness" reward button to generate the confirmation signal, where the confirmation signal is configured to indicate which personality category PC corresponds to the reward button selected by the user, serving as a reward for the prompt generator PG.

Accordingly, the processor 11 can train and update the prompt generator PG based on the reward to enhance the prompt generator PG, so that the best prompt BP generated by the prompt generator PG can better elicit the large language model LLM to generate a response message conforming to the personality categories PC.

Specifically, the processor 11 controls the human-machine interface to display the response message. Then, the processor 11 receives a confirmation signal from the human-machine interface and updates the prompt generator PG based on the confirmation signal.

Furthermore, in certain embodiments, the user can also operate the human-machine interface to input a reward suggestion in the form of a message to generate the confirmation signal, where the confirmation signal includes the reward suggestion input by the user.

In certain embodiments, to enable the large language model LLM to understand more complex input instructions, the prompt generating device 1 further enhances a plurality of training instructions based on an initial enhancement method, evaluates the initial enhancement method to generate an evolutionary enhancement method, then generate a plurality of enhanced instructions using the evolutionary enhancement method, and trains the large language model LLM based on the enhanced instructions. Accordingly, the large language model LLM can understand more complex input instructions.

It should be noted that the prompt generating device 1 can be communicatively connected to a cloud database, and the cloud database stores an instruction training dataset. The instruction training dataset includes a plurality of training instructions, a plurality of training labels corresponding to the training instructions, a plurality of test instructions, and a plurality of test labels corresponding to the test instructions. The training instructions or the test instructions may be any instructions, the training labels are replies corresponding to the training instructions, and the test labels are replies corresponding to the test instructions, where the forms of the aforementioned instructions and replies are all textual. For example, one training instruction is "How's the weather today?", and one training label corresponding to the training instruction is "The weather is very nice today".

It should be noted that the instruction training dataset may be an open-source dataset from the network (e.g., Alpaca Dataset, OASST1, or other instruction training datasets), or may be generated by manual collection.

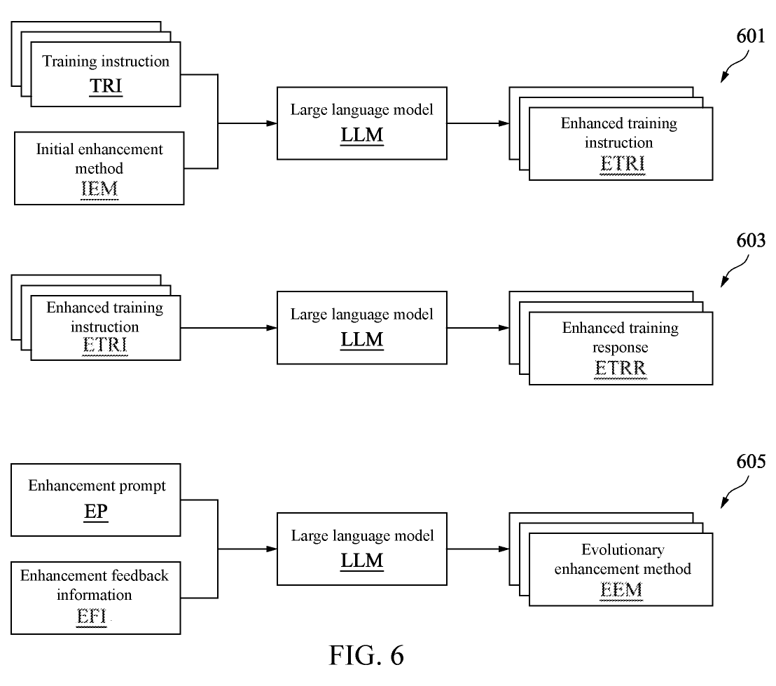

First, to enhance the training instructions, the prompt generating device 1 uses an initial enhancement method to generate a plurality of enhanced training instructions. For ease of explanation, please refer to a schematic diagram 601 of an enhanced training instruction generation process in FIG. 6. Specifically, the processor 11 transmits the training instructions TRI and an initial enhancement method IEM to the large language model LLM to generate a plurality of enhanced training instructions ETRI.

It should be noted that the initial enhancement method IEM may be a text defined manually, and the initial enhancement method IEM is configured to indicate an enhancement type corresponding to the training instructions TRI. For example, the initial enhancement method IEM is "Please enhance the input instruction using more complex grammar", where "more complex grammar" is the enhancement type corresponding to the training instructions TRI. Accordingly, the large language model LLM will generate the enhanced training instructions ETRI that conform to "more complex grammar".

Next, please refer to a schematic diagram 603 of an enhanced training response generation process in FIG. 6. Specifically, the processor 11 transmits the enhanced training instructions ETRI to the large language model LLM to generate a plurality of enhanced training responses ETRR corresponding to the enhanced training instructions ETRI.

In certain embodiments, to measure the quality of the enhanced training instructions ETRI and the enhanced training responses ETRR, specifically, the processor 11, based on the large language model LLM, analyzes the enhanced training instructions ETRI and compares the enhanced training responses ETRR with the training labels corresponding to the training instructions TRI, to generate the enhancement feedback information EFI.

It should be noted that in the present embodiment, the large language model LLM can be provided with a reward role prompt manually. The reward role prompt is configured to instruct the large language model LLM to measure the quality of the enhanced training instructions ETRI and the enhanced training responses ETRR under a specific role, task, style, scoring method, etc.

For example, the reward role prompt may be "Your role is a professional article reviewer responsible for evaluating the quality of rewritten articles. Each scoring must be objective and consistent. Your task is to analyze all instructions I provide and compare the responses generated by the instructions with the labels corresponding to the instructions. Your style must be professional and easy to understand, with clear structure and logical organization. Your scoring method is to analyze each instruction one by one based on the following evaluation criteria, give a score from 0 to 10, and explain the reasons in detail. The evaluation criteria include clarity, preservation of original meaning, depth, diversity of perspectives, diversity of vocabulary."

Then, please refer to a schematic diagram 605 of an evolutionary enhancement method generation process in FIG. 6. Specifically, the processor 11 transmits an enhancement prompt EP and a plurality of enhancement feedback information EFI to the large language model LLM to generate an evolutionary enhancement method EEM based on the initial enhancement method IEM.

It should be noted that the enhancement prompt EP is configured to guide the large language model LLM to perform a task of enhancing the initial enhancement method IEM. For example, the enhancement prompt EP is "Please further optimize the initial enhancement method according to the enhancement feedback information ", to instruct the large language model LLM to optimize the initial enhancement method IEM and thus generate the evolutionary enhancement method EEM.

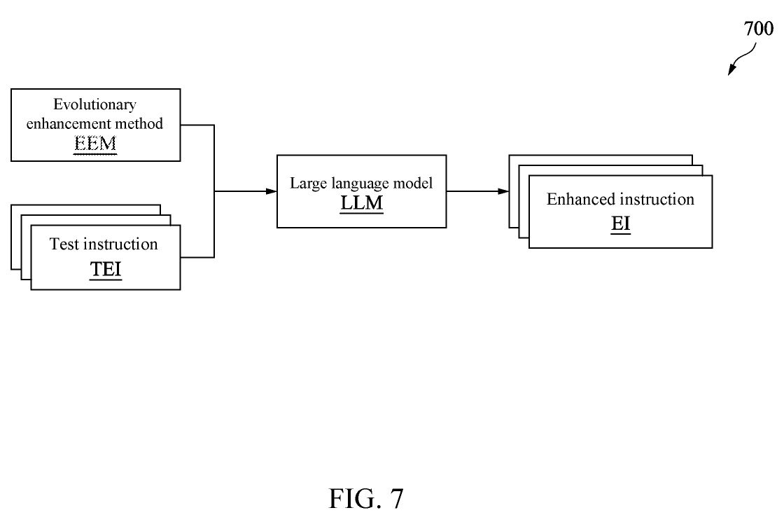

In certain embodiments, for ease of explanation, please refer to a schematic diagram 700 of an enhanced instruction generation process in FIG. 7. Specifically, the processor 11 transmits a plurality of test instructions TEI and the evolutionary enhancement method EEM to the large language model LLM to generate the enhanced instructions EI, where the evolutionary enhancement method EEM is generated based on the initial enhancement method IEM.

It should be noted that the evolutionary enhancement method EEM is configured to indicate an enhancement type corresponding to the test instructions TEI. Since the evolutionary enhancement method EEM is generated based on optimizing the initial enhancement method IEM (e.g., changing the narrative structure of the text, increasing the difficulty of the grammar, etc., based on the initial enhancement method IEM), the evolutionary enhancement method EEM has a greater "capability to enhance instructions" compared to the initial enhancement method IEM.

Then, the processor 11 trains the large language model LLM based on the enhanced instructions EI. Accordingly, the large language model LLM can understand more complex input instructions.

As can be seen from the above content, the prompt generating device 1 provided in the present disclosure converts a situational question into a plurality of candidate prompts through a prompt generator and determines a best prompt from the candidate prompts. Subsequently, the present disclosure trains the prompt generator through reinforcement learning based on a large language model and a reward model. Furthermore, the present disclosure transmits the best prompt to a large language model to generate a response message corresponding to the target personality category. Since the present disclosure can automatically generate prompts through the prompt generator trained based on reinforcement learning, the prompt generating device 1 provided in the present disclosure reduces the time cost of designing prompts and guides the large language model to effectively generate personalized replies.

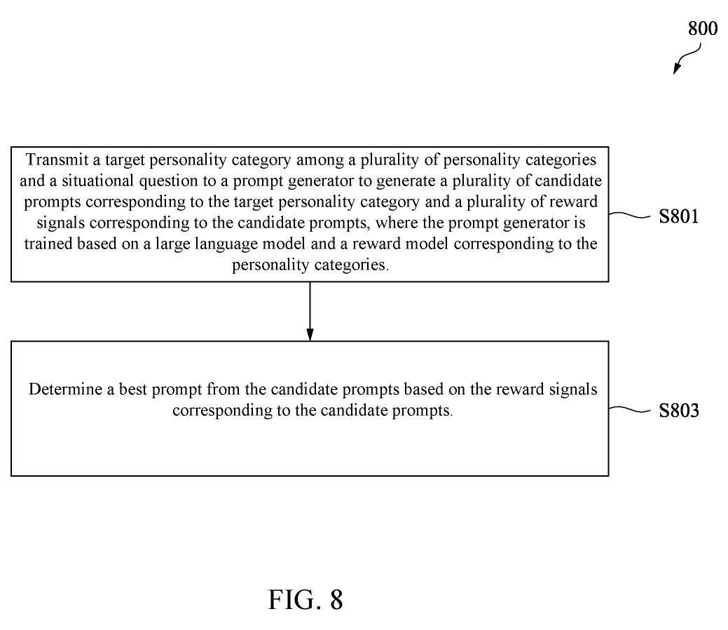

A second embodiment of the present disclosure is a prompt generating method, and its flowchart is illustrated in FIG. 8. The prompt generating method 800 is applicable to an electronic device, for example, the prompt generating device 1 described in the first embodiment. The prompt generating method 800 performs prompt generation through steps S801 to S803.

First, in step S801, the electronic device transmits a target personality category among a plurality of personality categories and a situational question to a prompt generator to generate a plurality of candidate prompts corresponding to the target personality category and a plurality of reward signals corresponding to the candidate prompts, where the prompt generator is trained based on a large language model and a reward model corresponding to the personality categories.

Next, in step S803, the electronic device determines a best prompt from the candidate prompts based on the reward signals corresponding to the candidate prompts.

In certain embodiments, the prompt generator is trained based on the following steps: transmitting a plurality of catalyst prompts to the large language model to generate a plurality of elicited responses corresponding to the catalyst prompts, where the catalyst prompts are generated based on the prompt generator; transmitting the elicited responses to the reward model to generate a plurality of personality reward information corresponding to the elicited responses, where each of the personality reward information includes a plurality of personality reward scores corresponding to the personality categories; and training the prompt generator based on the catalyst prompts and the personality reward information.

In certain embodiments, the reward model is trained based on the following step: training the reward model based on a plurality of training data corresponding to the personality categories.

In certain embodiments, the prompt generating method 800 further includes the following steps: transmitting the training data corresponding to the personality categories to an augmentation large language model to generate a plurality of augmented training data corresponding to the personality categories; and training the reward model based on the augmented training data corresponding to the personality categories.

In certain embodiments, the prompt generating method 800 further includes the following step: transmitting the best prompt to the large language model to generate a response message corresponding to the target personality category.

In certain embodiments, the prompt generating method 800 further includes the following steps: controlling a human-machine interface to display the response message; and receiving a confirmation signal from the human-machine interface, and updating the prompt generator based on the confirmation signal.

In certain embodiments, the large language model is trained based on the following steps: training the large language model based on a plurality of enhanced instructions and a plurality of test labels corresponding to the enhanced instructions.

In certain embodiments, the enhanced instructions are generated based on the following steps: transmitting a plurality of test instructions and an evolutionary enhancement method to the large language model to generate the enhanced instructions, where the evolutionary enhancement method is generated based on an initial enhancement method.

In certain embodiments, the evolutionary enhancement method is generated based on the following steps: transmitting a plurality of training instructions and the initial enhancement method to the large language model to generate a plurality of enhanced training instructions, where the initial enhancement method is configured to indicate an enhancement type corresponding to the training instructions; transmitting the enhanced training instructions to the large language model to generate a plurality of enhanced training responses; and transmitting an enhancement prompt and a plurality of enhancement feedback information to the large language model to generate the evolutionary enhancement method based on the initial enhancement method.

In certain embodiments, the enhancement feedback information is generated based on the following steps: analyzing the enhanced training instructions based on the large language model, and comparing the enhanced training responses with a plurality of training labels corresponding to the training instructions, to generate the enhancement feedback information.

In addition to the aforementioned steps, all operations and steps of the prompt generating device 1 described in the first embodiment may also be performed in the second embodiment, possess the same functions, and achieve the same technical effects. A person having ordinary knowledge in the technical field to which the present disclosure pertains can directly understand how the operations and steps in the second embodiment are performed based on the above first embodiment, possess the same functions, and achieve the same technical effects. Therefore, no further elaboration is provided.

In summary, according to the prompt generating technology (including at least the device and the method) provided in the present disclosure, a situational question is converted into a plurality of candidate prompts through a prompt generator, and a best prompt is determined from the candidate prompts. Subsequently, according to the present disclosure, the prompt generator is trained through reinforcement learning based on a large language model and a reward model. Furthermore, according to the present disclosure, the best prompt is transmitted to a large language model to generate one response message corresponding to the target personality category. Since according to the present disclosure, prompts can be automatically generated through the prompt generator trained based on reinforcement learning, the prompt generating technology provided in the present disclosure reduces the time cost of designing prompts and guides the large language model to effectively generate personalized replies.

The above embodiments are merely illustrative of some implementation aspects of the present disclosure and explain the technical features of the present disclosure, but are not intended to limit the scope and extent of protection of the present disclosure. Any modifications and equivalent alterations that can be easily accomplished by persons having ordinary knowledge in the technical field to which the present disclosure pertains fall within the scope claimed by the present disclosure, and the scope of protection shall be defined solely by the appended claims.

What is claimed is:

1. A prompt generating device, comprising:
a transceiver interface, configured to receive a situational question;
a storage, configured to store a prompt generator, a large language model and a reward model; and
a processor, electrically connected to the transceiver interface and the storage, and executing the following operations:
transmitting a target personality category among a plurality of personality categories and the situational question to the prompt generator to generate a plurality of candidate prompts corresponding to the target personality category and a plurality of reward signals corresponding to the candidate prompts, wherein the prompt generator is trained based on the large language model and the reward model corresponding to the personality categories; and
determining a best prompt from the candidate prompts based on the reward signals corresponding to the candidate prompts.

2. The prompt generating device according to claim 1, wherein the prompt generator is trained based on the following operations:
transmitting a plurality of catalyst prompts to the large language model to generate a plurality of elicited responses corresponding to the catalyst prompts, wherein the catalyst prompts are generated based on the prompt generator;
transmitting the elicited responses to the reward model to generate a plurality of personality reward information corresponding to the elicited responses, wherein each of the personality reward information comprises a plurality of personality reward scores corresponding to the personality categories; and
training the prompt generator based on the catalyst prompts and the personality reward information.

3. The prompt generating device according to claim 2, wherein the reward model is trained based on the following operation:
training the reward model based on a plurality of training data corresponding to the personality categories.

4. The prompt generating device according to claim 3, wherein the processor further executes the following operations:
transmitting the training data corresponding to the personality categories to an augmentation large language model to generate a plurality of augmented training data corresponding to the personality categories; and
training the reward model based on the augmented training data corresponding to the personality categories.

5. The prompt generating device according to claim 1, wherein the processor is further configured to execute the following operation:
transmitting the best prompt to the large language model to generate a response message corresponding to the target personality category.

6. The prompt generating device according to claim 5, wherein the processor further executes the following operations:
controlling a human-machine interface to display the response message; and
receiving a confirmation signal from the human-machine interface, and updating the prompt generator based on the confirmation signal.

7. The prompt generating device according to claim 1, wherein the large language model is trained based on the following operation:
training the large language model based on a plurality of enhanced instructions and a plurality of test labels corresponding to the enhanced instructions.

8. The prompt generating device according to claim 7, wherein the enhanced instructions are generated based on the following operation:
transmitting a plurality of test instructions and an evolutionary enhancement method to the large language model to generate the enhanced instructions, wherein the evolutionary enhancement method is generated based on an initial enhancement method.

9. The prompt generating device according to claim 8, wherein the evolutionary enhancement method is generated based on the following operations:
transmitting a plurality of training instructions and the initial enhancement method to the large language model to generate a plurality of enhanced training instructions, wherein the initial enhancement method is configured to indicate an enhancement type corresponding to the training instructions;
transmitting the enhanced training instructions to the large language model to generate a plurality of enhanced training responses; and
transmitting an enhancement prompt and a plurality of enhancement feedback information to the large language model to generate the evolutionary enhancement method based on the initial enhancement method.

10. The prompt generating device according to claim 9, wherein the enhancement feedback information is generated based on the following operations:
analyzing the enhanced training instructions based on the large language model, and comparing the enhanced training responses with a plurality of training labels corresponding to the training instructions, to generate the enhancement feedback information.

11. A prompt generating method, for use in an electronic device, wherein the electronic device receives a situational question, the electronic device stores a prompt generator, a large language model and a reward model, wherein the prompt generating method comprises the following steps:
transmitting a target personality category among a plurality of personality categories and the situational question to the prompt generator to generate a plurality of candidate prompts corresponding to the target personality category and a plurality of reward signals corresponding to the candidate prompts, wherein the prompt generator is trained based on the large language model and the reward model corresponding to the personality categories; and
determining a best prompt from the candidate prompts based on the reward signals corresponding to the candidate prompts.

12. The prompt generating method according to claim 11, wherein the prompt generator is trained based on the following steps:
transmitting a plurality of catalyst prompts to the large language model to generate a plurality of elicited responses corresponding to the catalyst prompts, wherein the catalyst prompts are generated based on the prompt generator;
transmitting the elicited responses to the reward model to generate a plurality of personality reward information corresponding to the elicited responses, wherein each of the personality reward information comprises a plurality of personality reward scores corresponding to the personality categories; and
training the prompt generator based on the catalyst prompts and the personality reward information.

13. The prompt generating method according to claim 12, wherein the reward model is trained based on the following step:
training the reward model based on a plurality of training data corresponding to the personality categories.

14. The prompt generating method according to claim 13, further comprising the following steps:
transmitting the training data corresponding to the personality categories to an augmentation large language model to generate a plurality of augmented training data corresponding to the personality categories; and
training the reward model based on the augmented training data corresponding to the personality categories.

15. The prompt generating method according to claim 11, further comprising the following step:
transmitting the best prompt to the large language model to generate a response message corresponding to the target personality category.

16. The prompt generating method according to claim 15, further comprising the following steps:
controlling a human-machine interface to display the response message; and
receiving a confirmation signal from the human-machine interface, and updating the prompt generator based on the confirmation signal.

17. The prompt generating method according to claim 11, wherein the large language model is trained based on the following step:
training the large language model based on a plurality of enhanced instructions and a plurality of test labels corresponding to the enhanced instructions.

18. The prompt generating method according to claim 17, wherein the enhanced instructions are generated based on the following step:
transmitting a plurality of test instructions and an evolutionary enhancement method to the large language model to generate the enhanced instructions, wherein the evolutionary enhancement method is generated based on an initial enhancement method.

19. The prompt generating method according to claim 18, wherein the evolutionary enhancement method is generated based on the following steps:
transmitting a plurality of training instructions and the initial enhancement method to the large language model to generate a plurality of enhanced training instructions, wherein the initial enhancement method is configured to indicate an enhancement type corresponding to the training instructions;
transmitting the enhanced training instructions to the large language model to generate a plurality of enhanced training responses; and
transmitting an enhancement prompt and a plurality of enhancement feedback information to the large language model to generate the evolutionary enhancement method based on the initial enhancement method.

20. The prompt generating method according to claim 19, wherein the enhancement feedback information is generated based on the following steps:
analyzing the enhanced training instructions based on the large language model, and comparing the enhanced training responses with a plurality of training labels corresponding to the training instructions, to generate the enhancement feedback information.
